(19) United States
(12) Patent Application Publication
(10) Pub. No.: US 2009/0321208 A1
(43) Pub. Date: Dec. 31, 2009

(54) SECONDARY DRIVE AXLE DISCONNECT FOR A MOTOR VEHICLE

(76) Inventors: Edward V. Schrand, Farmington Hills, MI (US); Frank T. Frederick, Rochester Hills, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 12/146,541

(22) Filed: Jun. 26, 2008

(51) Int. Cl. F16D 21/00

(52) U.S. Cl. 192/48.1

(57) ABSTRACT

An active drive disconnect system for a drivetrain of a motor vehicle controlling selective engagement of a first clutch and a second clutch while the vehicle is in motion without the need for synchronization. In the active drive disconnect the first clutch assembly is arranged for selective engagement of a secondary driveline with a primary driveline, and the second clutch is arranged for selectively connecting an axle half-shaft with a differential.

### FIELD OF THE INVENTION

The present invention relates to a drivetrain in a motor vehicle of the type having four-wheel or all-wheel drive capability, and, more particularly, to a system for actively disconnecting the secondary drive axle from the primary driveline without the need for synchronizing the disconnect.

### BACKGROUND OF THE INVENTION

Four-wheel and all-wheel drive vehicles are popular for their enhanced capabilities in inclement weather and off-highway conditions as compared with two-wheel drive vehicles. Such vehicles necessarily have a more complex drivetrain which, in addition to the primary driveline, employ a secondary driveline, e.g. with additional components, such as a secondary axle and a propshaft, and frequently also a transfer case.

Secondary driveline components introduce additional mass, inertia and friction to the: drivetrain, which in turn translates to increased fuel consumption. Although enhanced tractive capabilities are not needed for a vehicle traveling a paved highway in dry weather, all four-wheel and all-wheel drive vehicles permanently carry the additional driveline hardware. In some drivetrain designs secondary driveline components may be arranged whereby they can be selectively disconnected from the primary driveline. The secondary axle road wheels, however, will still be “back-driving” the secondary axle differential through the axle-shafts, and the resultant parasitic drag can nevertheless reduce a vehicle's fuel efficiency.

In an effort to reduce the parasitic drag caused by back-driven secondary driveline components, schemes for selectively disconnecting a secondary differential from at least one of its respective axle-shafts have been developed. These schemes typically disconnect a secondary axle-shaft from its differential via a dog clutch, i.e. by selectively removing a mechanical interference between an axle-shaft and the differential. However, in such a system, a sequential, i.e. synchronized, reconnection of the secondary driveline components may be required for smooth and trouble-free vehicle operation. Therefore, a system with a dog clutch typically does not lend itself to active “on-the-fly” operation, i.e. real-time reengagement without an operator interface or synchronization while the subject vehicle is in motion.

The present invention provides a system for actively engaging a motor vehicle's secondary driveline with its primary driveline without the need for synchronization and while eliminating back-driving of the disengaged secondary driveline.

### SUMMARY OF THE INVENTION

The present invention is a drive disconnect system for a drivetrain of a motor vehicle of the type having either four-wheel or all-wheel drive capability. The active drive disconnect system is an active system, meaning that it can be operated while the vehicle is in motion. The system includes a drivetrain having a primary driveline and a secondary driveline, wherein the primary driveline has a primary axle arranged to drive the vehicle, and the secondary driveline has a secondary axle, a differential and two axle half-shafts arranged for selective mechanical engagement with the primary axle. The system also includes an active drive disconnect which has a first clutch assembly arranged between the primary driveline and the secondary driveline for engaging the corresponding primary and secondary axles. The active drive disconnect also has a second clutch assembly having at least one friction plate connected driveably to the differential and at least one friction plate connected driveably to one of the two axle half-shafts. The second clutch assembly is arranged for engaging the differential with the one of the two axle half-shafts and thereby driving the engaged axle half-shafts. The active drive disconnect includes a controller mounted on the vehicle for controlling selective engagement of the two clutches in response to a signal representing one or more predetermined vehicle operating parameters. The selective engagement is performed while the vehicle is in motion, which can be accomplished without the need for synchronization.

The present invention also includes a means for energizing the second clutch, such as a fluid pump or an electric motor. Activation of either the pump or the electric motor to energize the second clutch can be accomplished via the controller.

It should be understood that the detailed description and specific examples which follow, while indicating preferred embodiments of the invention, are intended for purposes of illustration only and are not intended to limit the scope of the invention.

### BRIEF DESCRIPTION OF THE DRAWINGS

FIG. 1 is a schematic diagram of a typical motor vehicle drivetrain having primary and secondary drivelines.

FIG. 2 is a cross-sectional view of a typical secondary drive axle disconnect according to the prior art.

FIG. 3 is a schematic diagram of a motor vehicle drivetrain having primary and secondary drivelines employing an active drive disconnect according to the invention.

FIG. 4 is a cross-sectional side view of a secondary driveline, illustrating a secondary axle-shaft engaged via a second clutch assembly according to the invention.

FIG. 5 is a cross-sectional side view of an electrically actuated version of the second clutch assembly in an engaged state according to the invention.

FIG. 6 is a cross-sectional side view of a hydraulically actuated version of the second clutch assembly in a disengaged state according to the invention.

### DETAILED DESCRIPTION OF THE INVENTION

In general the present invention is directed to a drivetrain in a motor vehicle of the type having either four-wheel or all-wheel drive capability, and, more particularly, to a system for actively engaging the secondary drive axle in such a vehicle drivetrain without the need for synchronizing the disconnect. The term “disconnect”, as employed in the designation of the subject system, is used herein to describe both an engagement and a disengagement function performed in the vehicle drivetrain. The term “active” as employed herein denotes system function which is capable of being performed automatically, without operator control.

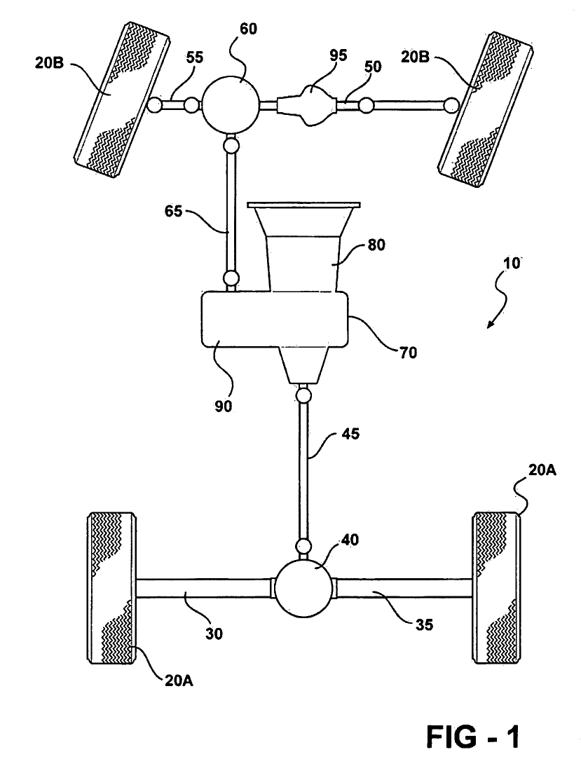

Referring now to the drawings in which like elements of the invention are identified with identical reference numerals throughout, FIG. 1 is a schematic diagram of a four-wheel or all-wheel drive drivetrain 10 of a motor vehicle having a primary driveline and a secondary driveline according to prior art. The primary driveline comprises a pair of drive wheels 20A connected to a primary axle which includes axle half-shafts 30 and 35 connected to differential 40, and prop-shaft 45 connected to transmission 80. The secondary driveline comprises a pair of drive wheels 20B, a secondary axle comprising axle half-shafts 50 and 55 connected at one end to drive wheels 20B and at their other end to differential 60. Prop-shaft 65 connects differential 60 to transfer case 70. Transfer case 70 is mounted to transmission 80 whereby it can function to selectively connect the secondary driveline to the primary driveline via engagement of clutch assembly 90.

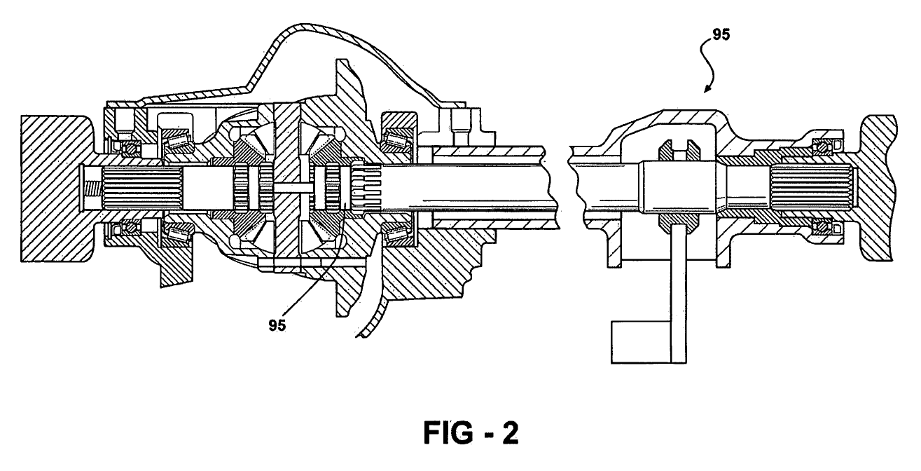

According to prior art, axle half-shaft 50 may also include a secondary axle disconnect via dog-clutch 95 to interrupt torque transmission from one of the secondary driveline drive wheels to differential 60, i.e. eliminate back-driving of the differential. FIG. 2 denotes a cross-sectional view of a secondary axle disconnect via dog clutch 95 according to prior art. Dog-clutch 95 may be used together with clutch assembly 90 to disconnect the secondary driveline from the primary driveline and also eliminate back-driving of differential 60. While it may be possible to disengage dog-clutch 95 without it being synchronized with clutch assembly 90 when the vehicle is on the move, the dog-clutch may only be reengaged without synchronization when the vehicle is stopped. Consequently, there are no available means in the prior art drivetrain for reconnection of the secondary driveline to the primary driveline without synchronization of the clutch assembly and the dog-clutch.

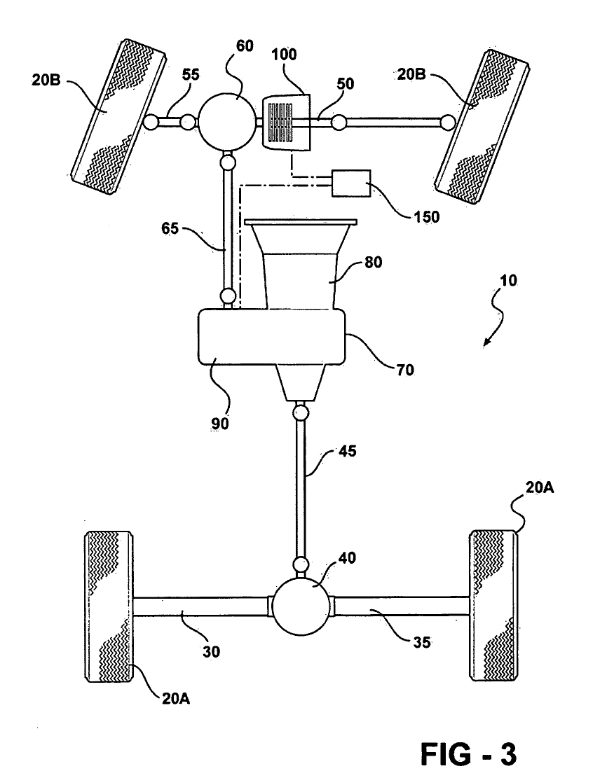

FIG. 3 is a schematic diagram of an active drive disconnect system for a four-wheel or an all-wheel drivetrain 10 according to the invention. The active drive disconnect system comprises a first clutch assembly 90 which is mounted between the primary driveline and the secondary driveline. As shown in FIG. 3, the first clutch assembly is located within the transfer case 70. First clutch assembly 90 is arranged for selective engagement of the two drivelines. The active drive disconnect also includes second clutch assembly 100 which interrupts secondary axle half-shaft 50. Second clutch assembly 100 may be configured to run dry, or it may be immersed in a specially formulated working fluid of the type used in limited slip differentials or automatic transmissions, i.e. it can be a wet-type clutch.

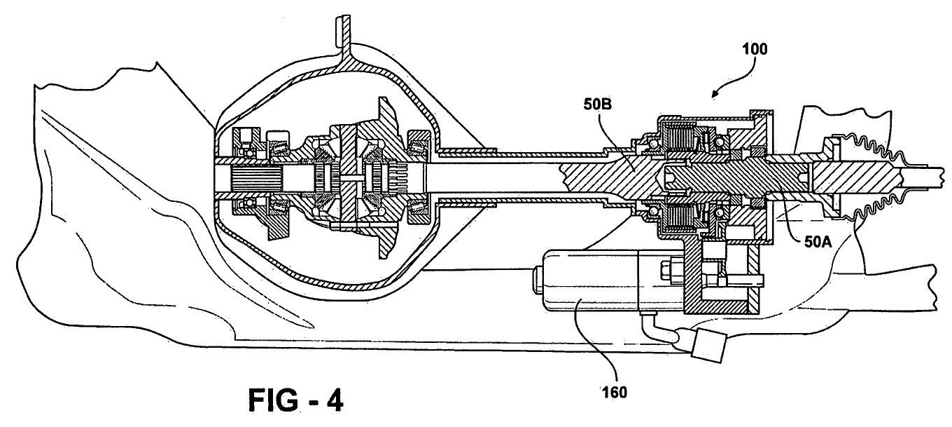

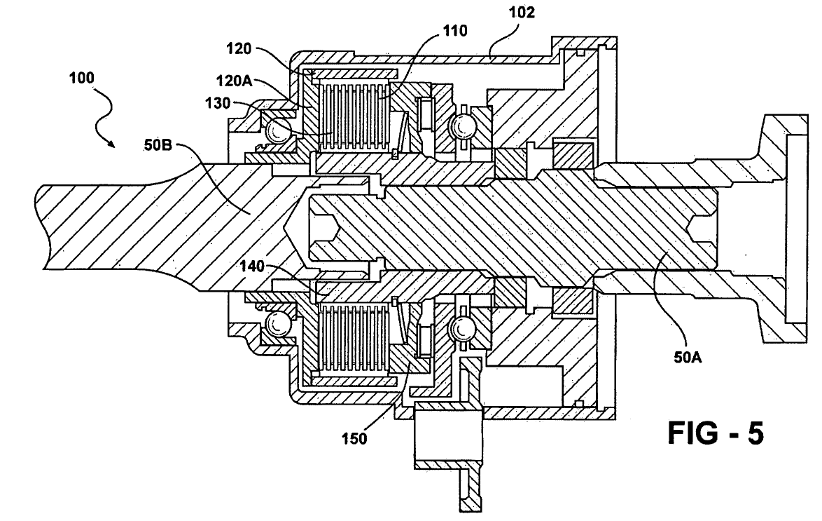

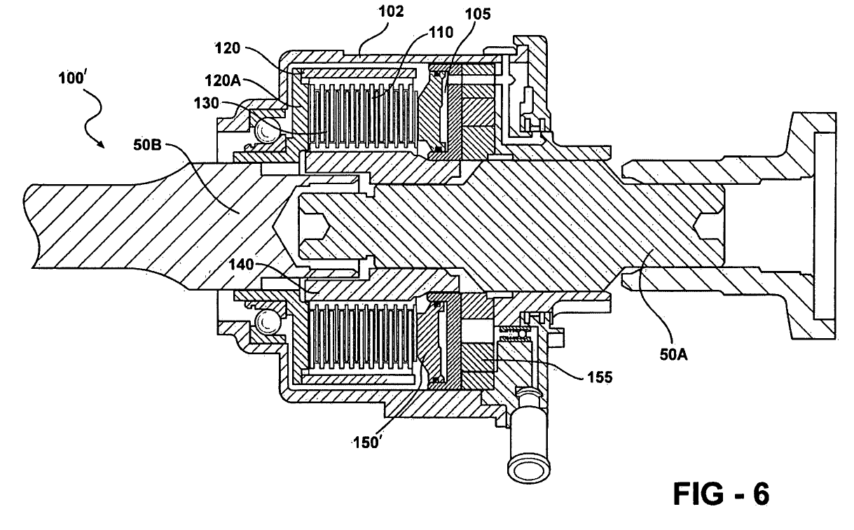

Two variants of second clutch assembly are shown in FIGS. 4-6. FIG. 4 denotes a cross-sectional side view of the secondary driveline and axle-shaft 50A and axle-shaft 50B engaged via an electrically actuated second clutch assembly 100 FIG. 5 shows a cross-sectional side view of an electrically actuated second clutch assembly 100, while FIG. 6 shows a cross-sectional side view of a hydraulically actuated second clutch assembly 100′. FIG. 5 shows an electrically actuated second clutch assembly 100 in an engaged state, wherein clutch friction plates 110 and 130 are clamped by a force being applied to slidably moveable clutch piston 150 in the direction of clutch retainer 120. FIG. 6 shows a hydraulically actuated second clutch assembly 100′ in a disengaged state, wherein there is no contact between clutch friction plates 110 and 130, and no friction plate contact with retainer 120 due to no force being applied to clutch piston 150′.

Second clutch assembly 100 (shown in FIG. 5) includes casing 102, which can be made from aluminum, or from another similarly high strength and temperature resistant material. Generally, aluminum is a preferred casing material for reasons of economy and weight. Casing 102 houses generally annular piston 150 slidably engaged with shaft 50A. Second clutch assembly 100 also includes generally annular friction plates 110 and reaction plates 130. Friction plates 110 and reaction plates 130 are arranged in alternating order, sandwiched between piston 150 and reaction surface 120A of retainer 120. Friction plates 110 have external diameter splines (not shown) which are used to engage retainer 120 via complementary splines on the retainer's internal diameter (not shown). Reaction plates 130 have internal diameter splines (not shown) which are used to engage sleeve 140 via complementary splines on the sleeve's external diameter (not shown). Retainer 120 is mechanically engaged with drive wheel 20B via shaft 50B, and sleeve 140 is mechanically engaged with differential 60 via shaft 50A.

Second clutch 100 is engaged, i.e. friction plates 110 and reaction plates 130 are clamped between reaction surface 120A and piston 150, by a force being applied on piston 150 urging friction plates 110 against reaction plates 130 and toward retainer 120. Shafts 50A and 50B are engaged, and a torque transfer chain is thereby created, when friction plates 110 and reaction plates 130 are clamped between piston 150 and retainer 120. For a hydraulically actuated second clutch assembly 100′ (shown in FIG. 6), piston 150′ is actuated, i.e. a force is applied, by a pressurized fluid supplied by pump 155 to pressure chamber 105. With respect to arrangement and function of friction plates 110, reaction plates 130 and reaction surface 120, second clutch assembly 100′ is identical to second clutch assembly 100. A force applied on piston 150′ urges friction plates 110 against reaction plates 130 and toward retainer 120 to engage shafts 50A and 50B.

Friction plates 110 and reaction plates 130 can be formed from any rigid, temperature resistant material, such as steel, with specially formulated fiction material bonded to both sides of each friction plate (not shown). Generally, steel is a preferred plate material for reasons of strength at elevated temperatures. The friction material has specific friction characteristics which allow friction plates 110 to slip relative to adjacent surfaces without damage as they are moved into contact and until they are fully clamped. In wet-type clutches, the working fluid is primarily adapted to enhance the clutch plates' friction coefficient and to remove excess heat generated by the slipping friction plates. Ability of the friction plates to slip without damage during engagement permits the second clutch assembly to absorb some difference in relative rotating speed between half-shaft 50 and prop-shaft 65 until the speed of one of the two shafts catches up to the other. This ability to absorb speed differences between the half-shaft and prop-shaft further allows first clutch 90 and second clutch assembly 100 (or second clutch assembly 100′) to be engaged smoothly at any vehicle road speed without the need for synchronization.

Electric motor 160, such as a direct current (DC) motor, in mechanical communication with piston 150, e.g. through a lever arrangement (not shown), or fluid pump 155 in fluid communication with piston 150′ may be employed to apply a desired force to the piston to engage the second clutch assembly. A fluid pump positioned externally (not shown) with respect to the second clutch assembly may be used in place of pump 155. Electric motor 160 or an external fluid pump can be mounted on the vehicle, in close proximity to the second clutch assembly. Electric motor 160, internal pump 155 or an external fluid pump may be actuated by an operator controlled switch located inside the passenger compartment of the vehicle, e.g. on the instrument panel (not shown), or automatically via an Electronic Control Unit (ECU).

Electric motor 160, internal fluid pump 155 an external fluid pump may be automatically actuated by an ECU in response to a signal detecting any one or more predetermined vehicle operating parameters that correspond to threshold loss of traction by the drive wheels. Generally, a particular minimum difference in rotational speed of the drive wheels will signify a threshold traction loss. Such minimum wheel speed difference may be predetermined, i.e. established empirically during the vehicle development phase under controlled conditions at an instrumented test-facility. For example, a development vehicle is run on various driving surfaces and the optimal point of actuation of the electric motor or the fluid pump for acceptable vehicle performance is identified and noted.

Sensors positioned in the vehicle at the individual wheels detect-wheel speeds. The wheel speed signals are communicated to a processor for comparison against the predetermined minimum wheel speed difference. The processor, generally incorporated into the ECU, calculates an actual wheel speed difference and compares it against the predetermined minimum value. The ECU issues a command to energize both first clutch 90 and second clutch assembly 100 (or second clutch assembly 100′) to engage the primary and the secondary drivelines when the actual wheel speed difference is greater than or equal to the predetermined minimum.

The active drive disconnect system may be employed in a hybrid-electric vehicle (HEV), i.e. a vehicle powered by a combination of an internal-combustion engine and a battery powered electric motor, equipped with a regenerative braking system. Typically, an HEV regenerative braking system employs a vehicle mounted generator that is arranged to be driven by the vehicle's drivetrain to recharge the accumulator when the braking system is applied to slow the vehicle. Generally, the amount of recharging power is directly proportional to braking energy dissipated at the wheels. In most vehicles front brakes provide a majority of braking power due to better traction at the front wheels, as well as for enhanced vehicle stability. Hence, especially in vehicles with the secondary driveline arranged in the front of the vehicle, drive wheels 20B must back-drive differential 60 to transfer the braking energy for driving the generator. Additionally, in order to obtain full recharging benefit of the vehicle's braking power, the primary and the secondary drivelines must be engaged when the brakes are applied. In such an HEV application, in addition to a fuel economy benefit, the present invention would facilitate regenerative braking by providing an active, seamless, non-synchronized engagement of the primary and the secondary drivelines.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An active drive disconnect system for a drivetrain of a motor vehicle, wherein the drivetrain comprises:
i) a primary driveline having a primary axle arranged to drive the vehicle; and
ii) a secondary driveline having a secondary axle, a differential and two axle half-shafts arranged for selective mechanical engagement with the primary axle;
wherein said active drive disconnect comprises:
i) a first clutch assembly mounted between the primary axle and the secondary axle and arranged for engaging the two axles; and
ii) a second clutch assembly mounted on the secondary axle having at least one friction plate connected driveably to the differential and at least one friction plate connected driveably to one of said two axle half-shafts arranged for engaging the differential with the one of said two axle half-shafts and thereby driving the one of said two axle half-shafts;
iii) a controller mounted on the vehicle for controlling the selective engagement of the two clutches while the vehicle is in motion in response to one or more signals of predetermined vehicle operating parameters without the need for synchronization.

2. The active drive disconnect system of claim 1 further comprising a casing having an annular pressure chamber surrounding the friction plates, an annular piston supported within the pressure chamber in perpendicular relationship to the friction plates and arranged for reciprocating movement relative to the friction plates from a first position wherein the piston is not in contact with the friction plates to a second position wherein said piston is in contact with one of said friction plates, and a fluid pump mounted on the vehicle in fluid communication with the pressure chamber for supplying a volume of fluid at elevated pressure against the annular piston to thereby clamp the friction plates.

3. The active drive disconnect system of claim 2 wherein the controller controls activation of the fluid pump in response to a detection of predetermined vehicle operating parameters.

4. The active drive disconnect system of claim 1 further comprising a casing having an annular pressure chamber for housing the friction plates, an annular piston supported within a chamber in perpendicular relationship to the friction plates and arranged for reciprocating movement relative to the friction plates from a first position wherein the piston is not in contact with the friction plates to a second position wherein said piston is in contact with one of said friction plates, and an electric motor mounted on the vehicle for applying a force against the annular piston to thereby clamp the friction plates.

5. The active drive disconnect system of claim 4 wherein the controller controls activation of the electric motor in response to a detection of predetermined vehicle operation parameters.

6. The active drive disconnect system of claim 1 further comprising at least one speed sensor located at each drive wheel of the vehicle for sensing changes in wheel speed and communicating said speed changes to the controller.

7. The active drive disconnect system of claim 1 wherein the controller is a manual switch.

8. The active drive disconnect system of claim 1 wherein the controller is an Electronic Control Unit (ECU).
